(19) United States
(12) Patent Application Publication
(10) Pub. No.: US 2026/0181762 A1
(43) Pub. Date: Jun. 25, 2026

(54) X-RAY INSPECTION APPARATUS

(71) Applicant: ANRITSU CORPORATION, Kanagawa (JP)

(72) Inventors: Motoki NARITA, Kanagawa (JP); Akihiro NODA, Kanagawa (JP); Hiro KUMAZAWA, Kanagawa (JP)

(21) Appl. No.: 19/408,447

(22) Filed: Dec. 4, 2025

(30) Foreign Application Priority Data
Dec. 20, 2024 (JP) 2024-225132

(51) Int. Cl. H05G 1/02; H05G 1/30

(52) U.S. Cl. CPC H05G 1/025; H05G 1/30

(57) ABSTRACT

An X-ray inspection apparatus that performs an inspection of an inspection object by detecting X-rays emitted to and transmitted through the inspection object includes: a housing; an X-ray detection portion that is disposed in the housing and detects the X-rays; an air conditioner that cools an inside of the housing; and first dehumidifying means and second dehumidifying means for dehumidifying the inside of the housing.

### TECHNICAL FIELD

The present invention relates to an X-ray inspection apparatus.

### BACKGROUND ART

In the related art, an X-ray inspection apparatus is used to detect foreign substances (metals, bones, glass, stones, synthetic resin materials, and the like) in various types of inspection objects (including surfaces) such as raw meat, fish, processed foods, and pharmaceuticals, for example. In the X-ray inspection apparatus, heat is generated by driving various electronic components such as an X-ray source or an X-ray detector. When these heats are trapped inside a housing, a temperature may exceed a specification temperature of the electronic component (for example, 40°C), so it is necessary to cool the inside of the housing and to reduce the temperature. In the X-ray inspection apparatus disclosed in Patent Document 1, an air conditioner is attached to a back surface of the housing, and the inside of the housing is cooled by a cooling portion of the air conditioner.

### Related art Document

### Patent Document

Patent Document 1 JP-A-2022-179006

### DISCLOSURE OF THE INVENTION

### Problem that the Invention is to Solve

The X-ray inspection apparatus has various configurations for cooling the X-ray source, the X-ray detector, and the like, and may include the air conditioner as described above. By providing the air conditioner, it is not necessary to take in outside air, and it is possible to suppress an increase in temperature due to heat generated from an electric unit constituting the X-ray inspection apparatus, while maintaining waterproofness or dustproofness in the environment in which the apparatus is used. In addition, the inside of the apparatus can be dehumidified by the dehumidifying function of the air conditioner. However, in a case where the air conditioner is stopped by controlling the cooling function such that the air conditioner maintains a constant temperature, air in which water droplets remaining in an evaporator of the air conditioner are vaporized flows into the inside of the apparatus, or high-humidity outside air enters the inside of the apparatus through a drain hose of the air conditioner, and thus the humidity inside the apparatus increases. Thereafter, in a case where the air conditioner restarts the operation, water droplets adhere to a surface of an electric component constituting the electric unit inside the apparatus, for example, a semiconductor chip, which may cause a failure.

The present invention has been made in view of the above circumstances, and an object of the present invention is to provide an X-ray inspection apparatus capable of suppressing a failure of an electric component, by preventing local dew condensation on a surface and surrounding of the electric component that may occur due to a temperature drop caused by cooling means for cooling an inside of the apparatus such as an air conditioner.

### Means for solving the problem

Next, means for solving the above problems will be described with reference to the drawings corresponding to an embodiment.

An X-ray inspection apparatus according to a first embodiment is an X-ray inspection apparatus that performs an inspection of an inspection object by detecting X-rays emitted to and transmitted through the inspection object, the X-ray inspection apparatus includes:

a housing;

an X-ray detection portion that is disposed in the housing and detects the X-rays;

an air conditioner that cools an inside of the housing; and first dehumidifying means and second dehumidifying means for dehumidifying the inside of the housing.

In the X-ray inspection apparatus, the inside of the housing is cooled by the air conditioner, and the inside of the housing is dehumidified by the first dehumidifying means and the second dehumidifying means. As a result, with the X-ray inspection apparatus, it is possible to prevent dew condensation of local electric components caused by cooling means such as the air conditioner, and suppress a failure of the electric components.

An X-ray inspection apparatus according to a second embodiment is the X-ray inspection apparatus according to the first embodiment, in which the first dehumidifying means is a dehumidifying function of the air conditioner.

In the X-ray inspection apparatus, even in a case where the inside of the housing is dehumidified by switching between cooling and dehumidification of the inside of the housing by using a function of the air conditioner, it is possible to reliably dehumidify the inside of the housing by using the second dehumidifying means without being affected by the operation of the air conditioner.

An X-ray inspection apparatus according to a third embodiment is the X-ray inspection apparatus according to the first embodiment, in which the second dehumidifying means is a dehumidifier dedicated to dehumidification.

An X-ray inspection apparatus according to a fourth embodiment is the X-ray inspection apparatus according to the second embodiment, in which the second dehumidifying means is a dehumidifier dedicated to dehumidification.

In the X-ray inspection apparatus, since the dehumidifier dedicated to dehumidification is used, it is possible to dehumidify the inside of the housing without being affected by the operation of the air conditioner. In addition, by providing a structure in which the dehumidifier independent of inspection apparatus control can operate alone, it is possible to dehumidify the inside of the housing without being affected by the operation of the X-ray inspection apparatus.

An X-ray inspection apparatus according to a fifth embodiment is the X-ray inspection apparatus according to the third embodiment, in which the second dehumidifying means is disposed in vicinity of the X-ray detection portion.

An X-ray inspection apparatus according to a sixth embodiment is the X-ray inspection apparatus according to the fourth embodiment, in which the second dehumidifying means is disposed in vicinity of the X-ray detection portion.

In the X-ray inspection apparatus, since cooling means such as a Peltier element provided in a module group in the X-ray detection portion is driven, water droplets due to condensation are likely to adhere to a semiconductor chip, but since the dehumidifier is disposed in the vicinity of the X-ray detection portion, it is possible to avoid a humid state of the X-ray detection portion, and it is possible to suppress a failure of the module group of the X-ray detection portion.

An X-ray inspection apparatus according to a seventh embodiment is the X-ray inspection apparatus according to the third embodiment, in which the second dehumidifying means is disposed on an air guide path of the X-ray detection portion.

An X-ray inspection apparatus according to an eighth embodiment is the X-ray inspection apparatus according to the fourth embodiment, in which the second dehumidifying means is disposed on an air guide path of the X-ray detection portion.

In the X-ray inspection apparatus, since disposition is made such that high-humidity air from the X-ray detection portion passes through the dehumidifier, it is possible to efficiently remove moisture and discharge the air to an outside of the housing. As a result, it is possible to avoid a humid state of the X-ray detection portion, and it is possible to suppress a failure of the module group of the X-ray detection portion.

### Advantage of the Invention

It is possible to prevent local condensation on a surface of an electric component and in the vicinity thereof, which may occur due to a decrease in temperature caused by the cooling means, such as the air conditioner, that cools the inside of the apparatus, and it is possible to suppress a failure of the electric component.

### BRIEF DESCRIPTION OF THE DRAWINGS

FIG. 1 is a side view of a housing portion of an X-ray inspection apparatus according to an embodiment.

### BEST MODE FOR CARRYING OUT THE INVENTION

Hereinafter, an embodiment according to the present invention will be described with reference to the drawings.

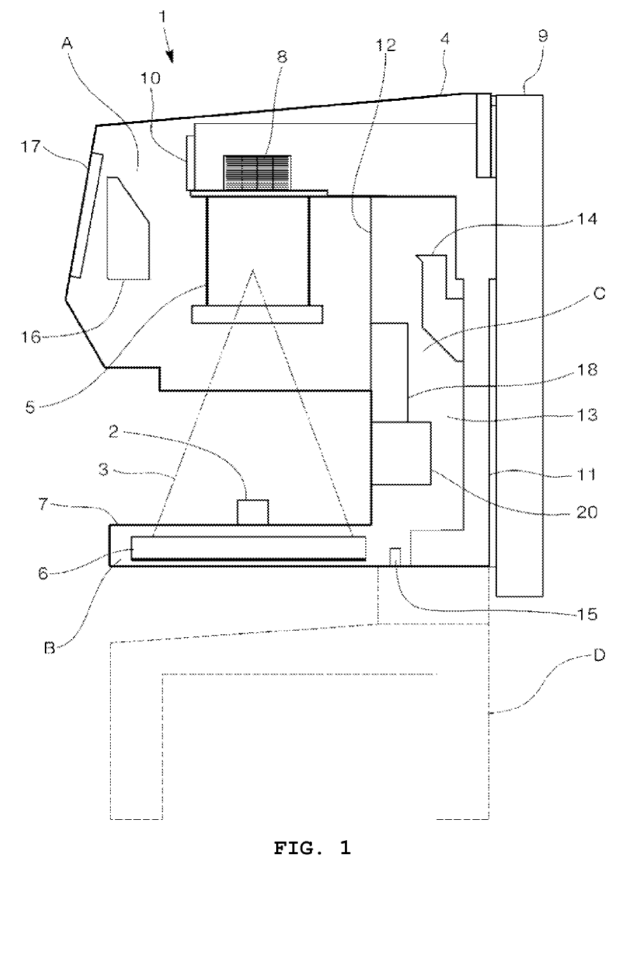

FIG. 1 is a side view of an X-ray inspection apparatus 1 according to the embodiment.

The X-ray inspection apparatus 1 according to the present embodiment inspects an inspection object 2 by irradiating the inspection object 2 with X-rays and detecting transmitted X-rays 3. As the inspection object 2, for example, raw meat, fish, processed foods, pharmaceuticals, and the like are used.

The X-ray inspection apparatus 1 includes an X-ray generation source 5 that generates the X-rays 3, an X-ray detection portion 6 that receives the X-rays 3 from the X-ray generation source 5, and transport means 7 that transports the inspection object 2 between the X-ray generation source 5 and the X-ray detection portion 6, in a housing 4. When the X-ray inspection apparatus 1 is used in an inspection step of a production line for foods, chemicals, and the like, for example, the inspection object 2 is sequentially conveyed from an upstream manufacturing step or processing step, and a predetermined inspection is repeated. The inspection result is displayed on an operation panel 17 and a signal is output to another apparatus. The inspected inspection object 2 is sequentially conveyed out to a downstream sorting step or packaging step.

In the present embodiment, the housing 4 is configured with an upper housing A that accommodates the X-ray generation source 5, a lower housing B that accommodates the X-ray detection portion 6, and a back housing C that connects the upper housing A and the lower housing B on a back side of the X-ray inspection apparatus 1 so as to form an irradiation region for irradiating the inspection object 2 with the X-rays 3, and is supported by a leg portion D.

The X-ray generation source 5 emits the X-ray 3 on the inspection object 2, which is transported by the transport means 7 provided with a conveyor belt that circulates and moves. The X-ray generation source 5 has a configuration in which a tank is provided, and the tank is filled with cooling oil to accommodate an X-ray tube serving as an X-ray source. A tank cooling portion provided on an upper surface of the tank has a heat dissipation fin 8 covered with a cover. The X-ray generation source 5 is disposed in the upper housing A of the housing 4, and irradiates the X-rays 3 downward. The X-ray 3 is irradiated in a substantially conical shape extending downward from the X-ray tube, and then becomes a planar shape extending downward via an elongated hole formed in a bottom portion of the X-ray generation source 5. In the X-ray generation source 5, heat generated when the X-ray 3 is generated is dissipated by a heat dissipation fin 8.

The X-ray detection portion 6 detects the X-ray 3 transmitting the inspection object 2, which is disposed in the lower housing B of the housing 4 and below the conveyor belt. The X-ray detection portion 6 has a slit and passes the planar X-ray 3 emitted from the X-ray generation source 5. The X-ray 3 passing through the slit is received by a sensor portion of the X-ray detection portion 6. In the sensor portion, a semiconductor chip, which is a detection element, is locally cooled by a Pelche element. The X-ray detection portion 6 photoconverts the X-ray 3, and outputs the resultant X-ray to an X-ray processing portion (not illustrated).

The housing 4 is provided with an air conditioner 9 as cooling means at a back portion. The air conditioner 9 has a refrigeration cycle. That is, the air conditioner 9 has a cooling function of cooling an inside of the housing 4 by passing air circulating inside the housing 4 through an evaporator, and a dehumidifying function of draining dew water generated in the evaporator and dehumidifying the inside of the housing 4 by passing weak air through the evaporator.

The air conditioner 9 has a built-in temperature sensor, and includes a controller that turns on a cooling operation when an operation start temperature on a high-temperature side is reached and turns off the cooling operation when a set temperature on a low-temperature side is reached, based on an output of this temperature sensor. This controller can also switch between the cooling operation and the dehumidifying operation of the air conditioner 9.

As the air conditioner 9, an air conditioner to which a high or low cooling performance is set based on a maximum increase in temperature determined by a volume of a space to be cooled or the amount of heat generated in the space, or an air conditioner having a predetermined cooling performance is selected. In particular, in a case where the amount of heat generated by the X-ray generation source 5 is large and high cooling performance is required, the large air conditioner 9 is attached to the back housing C of the housing 4.

The housing 4 includes an upper branch duct 10 that supplies air (cold air) from an air outlet of the air conditioner 9 to the X-ray generation source 5 of the upper housing A and a lower branch duct 11 that supplies the air to the X-ray detection portion 6 of the lower housing B. The air supplied from the air conditioner 9 to the X-ray generation source 5 and the X-ray detection portion 6 is returned from a suction duct 14 disposed in a return chamber 13 defined by a partition plate 12 partitioning the inside of the housing 4 to a suction port of the air conditioner 9 and circulates inside the housing 4. As a result, both the X-ray generation source 5 and the X-ray detection portion 6 are cooled.

A plurality of various electric components are provided as electric units inside the housing 4. Among them, there is a group of modules in which electric components having low durability against adhesion of water droplets, that is, vulnerable to dew condensation are mounted. An example of this module group includes a line sensor unit provided with a semiconductor chip adopted in the X-ray detection portion 6, and the like. The line sensor unit is vulnerable to heat, that is, an allowable range of operating temperatures is narrow, and the maximum operating temperature that defines an upper limit temperature during operation is approximately 20°C to 30°C lower than other electric units. Therefore, a Pelche element as cooling means for the line sensor unit is provided in contact with the semiconductor chip so as to locally exhaust heat from the semiconductor chip mainly by heat conduction, suppress the increase in temperature, and protect the line sensor unit from the heat. As such local cooling means, cooling means to which a high or low cooling performance is set based on the amount of heat and the operating temperature range of the electric component to be cooled, or cooling means having a predetermined cooling performance is selected. For example, when small cooling means such as a Pelche element is selected, a low-temperature surface of the Pelche element is brought into contact with the electric component side, heat is absorbed from the contact surface, and the heat is transferred to a high-temperature surface. The increase in temperature on the high-temperature surface is diffused inside the X-ray detection portion 6 by circulation of air by the air conditioner 9, and the heat is dissipated.

The X-ray inspection apparatus 1 is provided with a humidity sensor 15 that monitors a humidity inside the housing 4. The humidity sensor 15 may be disposed in the group of the modules in which the electric components vulnerable to dew condensation are mounted, that is, in the lower housing B or a lower portion of the back housing C of the housing 4 in the vicinity of the X-ray detection portion 6, which is a space in which the temperature drops due to the cooling of the Pelche element described above, which is local cooling means. As a result, it is possible to accurately detect a high humidity state in which dew condensation that causes a failure of the X-ray detection portion 6 is likely to occur.

The X-ray inspection apparatus 1 includes dehumidifying means for dehumidifying the inside of the housing 4. In the present embodiment, the dehumidifying means is implemented by a dehumidification operation that is a dehumidifying function of the air conditioner 9. The dehumidifying means is provided with the dehumidifier 20 (second dehumidifying means) dedicated to dehumidification in addition to the dehumidification operation (first dehumidifying means) using the evaporator of the air conditioner 9, and the dehumidifier 20 is provided in the vicinity of the X-ray detector 6 and on the air guide path in the housing 4. As a result, in a case where the air conditioner 9 is stopped, water droplets remaining in the evaporator can be condensed by the dehumidifier 20, and condensed water accumulated during the operation of the air conditioner does not remain in the evaporator, and an increase in humidity after a cooling operation of the air conditioner 9 is stopped can be suppressed. In addition, air around the X-ray detector 6 can be efficiently dehumidified since the dehumidifier 20 is disposed in the vicinity of the X-ray detector 6, and an increase in humidity in a case where the air conditioner 9 is stopped can be more effectively suppressed since the dehumidified air is taken into the evaporator of the air conditioner 9. Further, since the dehumidifier 20 is provided on the air guide path of the X-ray detector 6, moisture inside the housing 4 can be efficiently discharged to the outside of the housing 4. Drain water of the air conditioner 9 and the dehumidifier 20 is discharged to the outside of the housing 4 through a drain hose (not shown).

The X-ray inspection apparatus 1 includes a first control portion 16. The first control portion 16 includes a central processing unit (CPU), a storage portion, connection ports or communication interfaces for various sensors, and the like. The first control portion 16 controls to supply power to the module group when a humidity detected by the humidity sensor 15 is equal to or lower than a predetermined value, or controls to stop the supplying of power to the module group when the detected humidity is equal to or higher than the predetermined value. The operation panel 17 provided on a front surface of the housing 4 is connected to the first control portion 16.

In the housing 4, apart from the module group vulnerable to dew condensation, a module group (referred to as a non-condensation module group) that is not affected by dew condensation, that is, has a structure in which a failure is less likely to occur due to dew condensation or dew condensation itself is less likely to occur is provided. As the non-condensation module group, for example, the X-ray generation source 5 in which electric components are housed in a metal case filled with insulating oil, and which also serves as a heat generation source is used. Further, the X-ray inspection apparatus 1 includes a temperature sensor that monitors a temperature inside the housing 4. This temperature sensor may be provided at a plurality of positions, for example, such as in the vicinity of a unit that serves as a heat generation source such as the X-ray generation source 5, in the vicinity of the operation panel 17 having electric components vulnerable to heat, and the like, and may be connected to the first control portion 16 so as to output a high-temperature alarm at a temperature equal to or higher than a predetermined reference value.

The first control portion 16 outputs a control signal to the module group. The control signal referred to here is, for example, a voltage signal defined by a high level or a low level, and in another example, the control signal is a command signal for transmitting and receiving a predetermined command by serial communication. Such a control signal includes a power control signal that controls power supply to each electric unit. By turning off a switch by this power control signal, the power supplied to a specific electric unit can be cut off.

The first control portion 16 may cause the X-ray generation source 5 to start emitting the X-ray, and control to start an operation of the cooling function by the air conditioner 9 in a case where the temperature by the temperature sensor (not illustrated) is equal to or higher than a predetermined value.

Further, the X-ray inspection apparatus 1 includes a second control portion 18. The second control portion 18 controls communication with an external device and the like, and cooperates with the first control portion 16 to transmit and receive an electric signal according to an operating state, an inspection result, or the like of the X-ray inspection apparatus 1 to and from another device and a higher-level management system.

As the control of the X-ray inspection apparatus 1 by the first control portion 16, first, when main power supply is turned on by starting of the apparatus, a control program stored in the storage portion is read into the central processing unit (CPU) and an activation sequence is started. In the activation sequence, an initialization of each electric unit or an output of various sensors such as the humidity sensor and the temperature sensor is taken in to start a warm-up operation. With such a warm-up operation, the operating temperature of the electric unit is stabilized, a change in electric characteristic depending on a temperature change is suppressed, and performance is stabilized. In order to shorten a warm-up time, a warm-up heater with a fan may be provided.

When the warm-up operation is completed, a standby state for an inspection start is set, and the first control portion 16 can start an inspection by an operation of the operation panel 17. When the inspection start operation is performed by the operation panel 17, the X-ray generation source 5 emits X-rays having a predetermined intensity, or an operation start signal is output to a controller (not illustrated) to start the operation of the transport means 7, and a motor as a drive source is operated.

When the transport means 7 starts the operation, the second control portion 18 outputs a signal indicating that the X-ray inspection apparatus 1 can perform an inspection to another device or a higher-level management system.

The X-ray inspection apparatus 1 inspects the inspection object 2 which is sequentially conveyed. A result of the inspection is displayed on the operation panel 17, and is output from the second control portion 18 to another device and a higher-level management system.

Next, for example, in a case where the temperature by the temperature sensor is equal to or higher than a predetermined value, the first control portion 16 turns on the cooling operation of the air conditioner 9 and suppresses an increase in temperature inside the housing 4 when an ambient temperature due to heat generated from the X-ray generation source 5 sharply rises, such as a case where an intensity of the X-rays 3 to be irradiated is strong. Further, the first control portion 16 compares a detected value from the humidity sensor 15 with a preset threshold value. At this time, when the detected humidity of the humidity sensor 15 is higher than the threshold value, that is, in the high humidity state, in order to suppress occurrence of dew condensation, first, the dehumidifying operation of the air conditioner 9 is turned on so as to lower the humidity without lowering the temperature inside the housing 4, and the inside of the housing 4 is dehumidified. The first control portion 16 compares a detected value from the humidity sensor 15 with the threshold value, and stops the dehumidifying operation of the air conditioner 9 and turns on the cooling operation if the detected humidity inside the housing 4 becomes lower than the threshold value.

Further, the first control portion 16 outputs a power control signal for cutting off the power supply to the module group, and outputs a high humidity alarm and stops the X-ray inspection so as to turn off the power supply to the module group in which dew condensation is likely to occur while the air conditioner 9 is dehumidifying, that is, while the humidity sensor 15 detects the high humidity state.

After stopping the X-ray inspection, the first control portion 16 stops the signal indicating that the inspection is possible for another device before and after. When the high humidity state is lost due to the dehumidifying operation of the air conditioner 9, the power supply is turned on again for the module group in which dew condensation is likely to occur, and the inspection is started.

The first control portion 16 may switch and control the cooling operation and the dehumidifying operation of the air conditioner 9 in consideration of the detected values of the temperature sensor and the humidity sensor 15. For example, when the temperature detected by the temperature sensor is equal to or lower than the operation start temperature of the air conditioner 9 and the humidity detected by the humidity sensor 15 is high, the dehumidifying operation is performed, and in a case where both the temperature and the humidity are high, the cooling operation is performed.

Both the cooling operation and the dehumidifying operation of the air conditioner 9 have a dehumidifying effect since water vapor is liquefied and discharged in a heat exchanger. Therefore, even in a case where the air conditioner 9 does not have the dehumidifying function, based on the detected value of the humidity sensor 15, the first control portion 16 may control the air conditioner 9 so as to suppress dew condensation of the module group, in preference to a condition that the increase in temperature inside the housing 4 requires the cooling operation. In a case where the threshold value is, for example, a relative humidity of 60%, the first control portion 16 monitors the humidity, and turns on the power of the module group when the relative humidity becomes 60% or lower. When the relative humidity exceeds 60%, the power of the module group is controlled to be turned off.

Here, for example, an example in which the X-ray inspection apparatus 1 is installed in a meat processing line at which washing using high-temperature steam is routinely performed will be described.

In a case where a temperature of an atmosphere is 30°C and a relative humidity is 80%, an absolute humidity is approximately 0.022 kg/kg (DA) from the psychrometric chart. The amount of water vapor in the air at this time corresponds to approximately 22 g/m³. In a case where the temperature of the atmosphere inside the housing 4 is 25°C and the relative humidity is 60% due to the dehumidifying function of the air conditioner 9, the absolute humidity is approximately 0.012 kg/kg (DA) from the psychrometric chart. The amount of water vapor in the air at this time corresponds to approximately 12 g/m³. Therefore, approximately 10 g/m³ is dehumidified inside the housing 4, and the atmosphere is such that the module group is less likely to cause dew condensation.

Immediately after the meat processing line is stopped, a surface of the housing 4 or the transport means 7 of the X-ray inspection apparatus 1 are washed with high-temperature steam. In addition to fats of attached meats being washed away by the high-temperature steam, the area around the apparatus becomes in a humid state. The meat processing line is left to stand until the meat processing line is restarted, but the housing 4 sucks in the outside air in the humid state from a slight gap of a cover or a door due to a decrease in air pressure due to a decrease in internal temperature. In this manner, the air in the humid state is taken into the housing 4.

When the main power supply of the X-ray inspection apparatus 1 is turned on for restarting, the warm-up operation is started.

During the inspection operation of the X-ray inspection apparatus 1, the X-ray generation source 5 becomes hot and the air conditioner 9 is frequently operated, so that the X-ray inspection apparatus 1 is in a certain dehumidifying state. The amount of heat generated becomes large when the X-ray generation source 5 emits X-rays with an intensity equal to or higher than a predetermined level although the amount of heat depends on the atmosphere in which the X-ray inspection apparatus 1 is installed. Therefore, it is found that the humidity is generally below the threshold value due to continuous dehumidification by the cooling operation of the air conditioner 9. However, if the air in the humid state exists inside the housing 4 immediately after the warm-up operation is completed, the inspection is started, and the like, dew condensation may occur in the locally low-temperature portion, that is, the locally cooled X-ray detection portion 6. During the inspection operation, for example, if the detected humidity exceeds the threshold value, a dew condensation alarm may be issued.

In the example described above, after the main power supply of the X-ray inspection apparatus 1 is turned on and the warm-up operation is completed, the air in the humid state exists around the X-ray detection portion 6, and dew condensation is likely to occur in the vicinity of the Pelche element that locally cools the semiconductor chip of the line sensor unit constituting the X-ray detection portion 6.

Next, an action of the above configuration will be described.

In the X-ray inspection apparatus 1 according to the present embodiment, the cooling means is provided inside the housing 4. In order to protect the electric components from heat, the cooling means sends cold air to the X-ray generation source 5 and the X-ray detection portion 6, for example, and perform cooling by heat transfer by circulating and transporting the cold air inside the housing 4, and promotes heat dissipation from the electric components. Further, in the X-ray inspection apparatus 1, the X-ray detection portion 6 detects X-rays 3 transmitted by irradiating the inspection object 2. The Pelche element as local cooling means is provided in contact with the X-ray detection portion 6 to protect the semiconductor chip of the line sensor unit from heat mainly by heat conduction. That is, the X-ray detection portion 6 is a module group that operates in a cold state. Therefore, it can be said that the X-ray detection portion 6 is a group of modules in which dew condensation is likely to occur due to cooling of the local cooling means, there is a risk of failure due to adhesion of dew condensation water droplets, and electric components that are vulnerable to dew condensation are mounted.

In the related art, if the module group including the Pelche element is operated at the same time in a standby state in which the main power supply of the X-ray inspection apparatus 1 is turned on and an inspection can be started, dew condensation occurs in the module group due to a local temperature difference (or relative humidity), and water droplets adhere to a surface of the electric component, which causes a failure of the semiconductor chip.

In the X-ray inspection apparatus 1 of the present embodiment, a humidity in the vicinity of the module group that is vulnerable to dew condensation inside the housing 4 is monitored by the humidity sensor 15. The first control portion 16 controls the supplying of power to each electric unit, based on a detected value of the humidity sensor 15. If the humidity by the humidity sensor 15 is equal to or higher than a predetermined value, the X-ray detection portion 6 having the module group vulnerable to dew condensation is not turned on. As a result, it is possible to suppress that when the humidity is high, the Pelche element provided in the module group in the X-ray detection portion 6 is not driven, so that the line sensor unit fails due to water droplets adhering to the semiconductor chip of the line sensor unit, for example. In a case where the detected value of the humidity sensor 15 is equal to or lower than the predetermined value, the first control portion 16 performs supplying of power to the module group, that is, the X-ray detection portion 6. Therefore, with the X-ray inspection apparatus 1, dew condensation of the module group integrally provided with the local cooling means can be effectively suppressed.

In consideration of only the semiconductor chip of the line sensor unit constituting the X-ray detection portion 6, when the main power supply of the X-ray inspection apparatus 1 is turned on and the warm-up operation is completed, first, the first control portion 16 monitors the detected value of the humidity sensor 15, and if the humidity is equal to or higher than the threshold value, the inside of the housing 4 is dehumidified by the dehumidifying operation of the dehumidifying means (air conditioner 9), in a state in which only the power supplied to the semiconductor chip and its peripheral circuits is turned off. In a case where the detected value of the humidity sensor 15 falls below the threshold value, for example, when the main power supply is turned on at a state of the initial relative humidity of 90% and dehumidification is performed, and when the internal relative humidity falls below 70% to 60%, the first control portion 16 turns on the power supply to the semiconductor chip and its peripheral circuits. That is, after suppressing the humidity to some extent, the power of the module group that is vulnerable to dew condensation is turned on. As a result, the X-ray inspection apparatus 1 can solve the problem that dew condensation occurs in the module group, especially at the start of the operation. After that, an operation as an apparatus, that is, an inspection will start.

As a result, with the X-ray inspection apparatus 1, it is possible to prevent dew condensation of the electric components due to the cooling of the local cooling means and suppress the failure of the electric components.

In this X-ray inspection apparatus 1, the cooling means includes the air conditioner 9. The including of the air conditioner 9 means that the Pelche element described above is also included as the cooling means. The cooling means is the air conditioner 9 that circulates cold air inside the housing 4 to cool the space inside the housing 4, and is also a cooling unit such as the Pelche element integrally incorporated in a specific module group to locally cool the module group. The humidity sensor 15 may be disposed in the vicinity of the module group in the X-ray detection portion 6, at a position at which the cooling by the cooling unit such as the Pelche element reaches.

The air conditioner 9 has the dehumidifying function. The air conditioner 9 has a refrigeration cycle in which a compressor, a condenser, an expansion valve, an evaporator, and the like are connected by piping to circulate refrigerants, to form a heat exchanger as a general structure. The refrigerant compressed from the compressor into heated steam is sent to the condenser and cooled to become a liquid. This liquid refrigerant evaporates in the evaporator by passing through the expansion valve, and cools the evaporator by taking away the heat of vaporization. By sending air from a blower fan to this evaporator, the heat-exchanged cold air is supplied to the inside of the housing 4.

The dehumidifying function of the air conditioner 9 utilizes the dew condensation in the evaporator at this low temperature. That is, the evaporator is cooled up to a dew point temperature with respect to the relative humidity of the air inside the housing 4 sent by the blower fan, and water vapor is discharged to the outside of the apparatus as dew water and removed.

The purpose of dehumidification is to remove moisture in the atmosphere, and cold air is blown out from the evaporator in the same manner as cooling. In a case where only dehumidification is required and cooling is not required, the blown air is reheated. As a result, the relative humidity can be significantly reduced without changing the temperature inside the housing 4, and the atmosphere inside the housing 4 can be made less likely to cause dew condensation. Further, in the X-ray inspection apparatus 1, the X-ray generation source 5 is desired to be warmed. Meanwhile, the X-ray generation source 5 is not desired to be heated up to a high temperature. The module group having the semiconductor chip has different demands for warming but cooling. Therefore, the operating temperature of each electric unit inside is stabilized by the warm-up operation at the start of the operation, and the air conditioner 9 performs not only the dehumidifying operation but also the cooling operation. The X-ray inspection apparatus 1 can cool the inside of the housing 4 and dehumidify the inside of the housing 4, by using the function of the air conditioner 9.

Further, by using the air conditioner 9 that circulates cold air inside the housing 4 of the X-ray inspection apparatus 1 in combination with the cooling means such as the Pelche element that locally cools the contact surface, the cooling and the dehumidification inside the housing 4 and the cooling of the module group that is vulnerable to dew condensation can be respectively achieved in a well-balanced manner.

With this X-ray inspection apparatus 1, in a case where the temperature detected by the temperature sensor becomes equal to or higher than the predetermined value, the operation of the cooling function by the air conditioner 9 is started. That is, for example, the X-ray generation source 5 or the like is heated by energization, and then the cooling function or the dehumidifying function of the air conditioner 9 is turned on. As a result, it becomes possible to maintain the temperature inside the housing 4 stabilized by the warm-up operation, a performance change of the electric unit due to a temperature change can be suppressed, and the performance of the X-ray inspection apparatus is stabilized. The X-ray generation source 5 has the tank, and the tank is filled with cooling oil to accommodate the X-ray source. The tank cooling portion provided on the upper surface of the tank has the heat dissipation fin covered with the cover. At a start of the operation, the X-ray inspection apparatus 1 requires the warm-up operation so as to bring the X-ray source to a predetermined temperature. However, in order to avoid becoming too warm, that is, a high-temperature state, cooling by the air conditioner 9 is required. As a result, the warm-up operation can be performed and the inside of the housing 4 can be dehumidified.

Therefore, with the X-ray inspection apparatus 1 according to the present embodiment, it is possible to prevent dew condensation of the electric components while cooling the inside of the housing 4 and suppress a failure of the electric components.

### Description of Reference Numerals and Signs

1 ... X-ray inspection apparatus

2 ... Inspection object

3 ... X-ray

4 ... Housing

5 ... X-ray generation source (non-condensation module group)

6 ... X-ray detection portion (module group)

9 ... Air conditioner (dehumidifying means, cooling means)

15 ... Humidity sensor

16 ... First control portion (control portion)

20 ... Dehumidifier

What is claimed is:

1. An X-ray inspection apparatus that performs an inspection of an inspection object by detecting X-rays emitted to and transmitted through the inspection object, the X-ray inspection apparatus comprising:
a housing;
an X-ray detection portion that is disposed in the housing and detects the X-rays;
an air conditioner that cools an inside of the housing; and
first dehumidifying means and second dehumidifying means for dehumidifying the inside of the housing.

2. The X-ray inspection apparatus according to claim 1,
wherein the first dehumidifying means is a dehumidifying function of the air conditioner.

3. The X-ray inspection apparatus according to claim 1,
wherein the second dehumidifying means is a dehumidifier dedicated to dehumidification.

4. The X-ray inspection apparatus according to claim 2,
wherein the second dehumidifying means is a dehumidifier dedicated to dehumidification.

5. The X-ray inspection apparatus according to claim 3,
wherein the second dehumidifying means is disposed in vicinity of the X-ray detection portion.

6. The X-ray inspection apparatus according to claim 4,
wherein the second dehumidifying means is disposed in vicinity of the X-ray detection portion.

7. The X-ray inspection apparatus according to claim 3,
wherein the second dehumidifying means is disposed on an air guide path of the X-ray detection portion.

8. The X-ray inspection apparatus according to claim 4,
wherein the second dehumidifying means is disposed on an air guide path of the X-ray detection portion.
